(19) United States
(12) Patent Application Publication
(10) Pub. No.: US 2013/0173425 A1
(43) Pub. Date: Jul. 4, 2013

(54) CONSUMER-INITIATED FINANCIAL TRANSACTION BASED ON SALES-SIDE INFORMATION

(71) Applicants: Sridhar Jagannathan, Los Altos, CA (US); Omar Green, San Francisco, CA (US)

(72) Inventors: Sridhar Jagannathan, Los Altos, CA (US); Omar Green, San Francisco, CA (US)

(73) Assignee: INTUIT INC., Mountain View, CA (US)

(21) Appl. No.: 13/341,129

(22) Filed: Dec. 30, 2011

(51) Int. Cl. G06Q 30/06

(52) U.S. Cl. 705/26.41

(57) ABSTRACT

During a financial transaction, an electronic device associated with a consumer receives an electronic package from a counterparty in the financial transaction. This electronic package includes sales-side information associated with the financial transaction. Then, the electronic device analyzes the electronic package to extract the sales-side information. Moreover, the electronic device provides the sales-side information and payment information to a third party that completes the financial transaction, thereby allowing the consumer to initiate the payment process. Next, the electronic device receives confirmation from the third party when the financial transaction has been completed.

### CROSS REFERENCE TO RELATED APPLICATIONS

This application is related to U.S. patent application Ser. No. 13/285,636, entitled “Conducting a Financial Transaction Using a Dynamically Generated Barcode,” by Jonathan W. Brockman et al., which was filed on Oct. 31, 2011, the contents of which are herein incorporated by reference.

### BACKGROUND

The present disclosure relates to a technique which enables a consumer to conduct a financial transaction. More specifically, in this technique, the consumer initiates completion of the financial transaction in response to receiving sales-side information associated with the financial transaction from a counterparty.

Credit and debit cards remain popular financial instruments for conducting financial transactions. However, during these financial transactions sensitive financial information associated with credit and debit cards remains vulnerable to theft and misuse.

For example, when conducting a financial transaction (such as paying for a product or a service) a customer typically gives their credit or debit card to a representative of a counterparty in the financial transaction. This representative may bring the credit or debit card to a point-of-sale terminal (such as a cash register) where they swipe the credit or debit card so that the associated financial information can be accessed and provided to a financial institution that issued the credit or debit card. In this way, the financial transaction can be completed. However, during this process the customer's credit or debit card is out of their sight, which increases the risk of theft or misuse of the associated financial information.

### SUMMARY

The disclosed embodiments relate to an electronic device that conducts a financial transaction. During operation, the electronic device receives from a counterparty in the financial transaction an electronic package which includes sales-side information associated with the financial transaction. Then, the electronic device analyzes the electronic package to extract the sales-side information. Moreover, the electronic device provides the sales-side information and payment information to a third party, where the process of providing is initiated by a consumer in the financial transaction, and the third party completes the financial transaction. Next, the electronic device receives confirmation from the third party when the financial transaction has been completed.

Note that the electronic package may include an image, and analyzing the electronic package may involve image processing of the image. For example, the image may include a two-dimensional spatial pattern, such as a barcode and/or a Quick Response code. In some embodiments, receiving the electronic package may involve capturing the image.

Furthermore, the sales-side information may include types of financial instruments accepted by the counterparty, which may allow the counterparty to restrict or limit the financial instruments that they accept in the financial transaction. After extracting the sales-side information, the electronic device may receive a selection of one of the types of financial instruments from the consumer, and the payment information may include the selected type of financial instrument.

In some embodiments, after receiving the confirmation, the electronic device provides the confirmation to the counterparty. Alternatively, the counterparty may receive the confirmation from the third party.

Additionally, the third party may include a financial institution that provides the selected type of financial instrument to the consumer.

Moreover, the electronic package may include information specifying one or more locations (such as a link to a web page or website) where the financial transaction can be completed.

Note that the financial transaction may be completed without providing the counterparty financial information about the financial instrument used by the consumer to conduct the financial transaction. In this way, security of the financial information may be increased.

Another embodiment provides a method that includes at least some of the operations performed by the electronic device.

Another embodiment provides a computer-program product for use with the electronic device. This computer-program product includes instructions for at least some of the operations performed by the electronic device.

### BRIEF DESCRIPTION OF THE FIGURES

FIG. 1 is a flow chart illustrating a method for conducting a financial transaction in accordance with an embodiment of the present disclosure.

FIG. 2 is a flow chart illustrating a method for conducting a financial transaction in accordance with an embodiment of the present disclosure.

FIG. 3 is a block diagram illustrating a system that performs the method of FIGS. 1-2 in accordance with an embodiment of the present disclosure.

FIG. 4 is a block diagram illustrating an electronic device that performs the method of FIGS. 1-2 in accordance with an embodiment of the present disclosure.

FIG. 5 is a block diagram illustrating a data structure for use with the electronic device of FIG. 4 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of an electronic device, a technique for conducting a financial transaction, and a computer-program product (e.g., software) for use with the electronic device are described. During this financial technique, the electronic device associated with a consumer receives an electronic package from a counterparty in a financial transaction. This electronic package includes sales-side information associated with the financial transaction. Then, the electronic device analyzes the electronic package to extract the sales-side information. Moreover, the electronic device provides the sales-side information and payment information to a third party that completes the financial transaction, thereby allowing the consumer to initiate a payment process. Next, the electronic device receives confirmation from the third party when the financial transaction has been completed.

By facilitating the financial transaction while protecting the security of the consumer's sensitive financial information, this financial technique may reduce theft and misuse of the consumer's financial information. As a consequence, the financial technique may reduce criminal activity (and the associated expenses). Therefore, the financial technique may increase consumer confidence in the safety of their financial information and commercial activity. In addition, because the consumer initiates completion of the financial transaction (instead of the counterparty), the financial technique may be consumer-centric. As such, it may reduce the time needed for financial innovations to gain traction in the marketplace.

In the discussion that follows, the user (e.g., a consumer in the financial transaction) and/or the counterparty may include: an individual (for example, an existing customer, a new customer, a service provider, a vendor, a contractor, etc.), an organization, a business and/or a government agency. Furthermore, a ‘business’ should be understood to include: for-profit corporations, non-profit corporations, organizations, groups of individuals, sole proprietorships, government agencies, partnerships, etc.

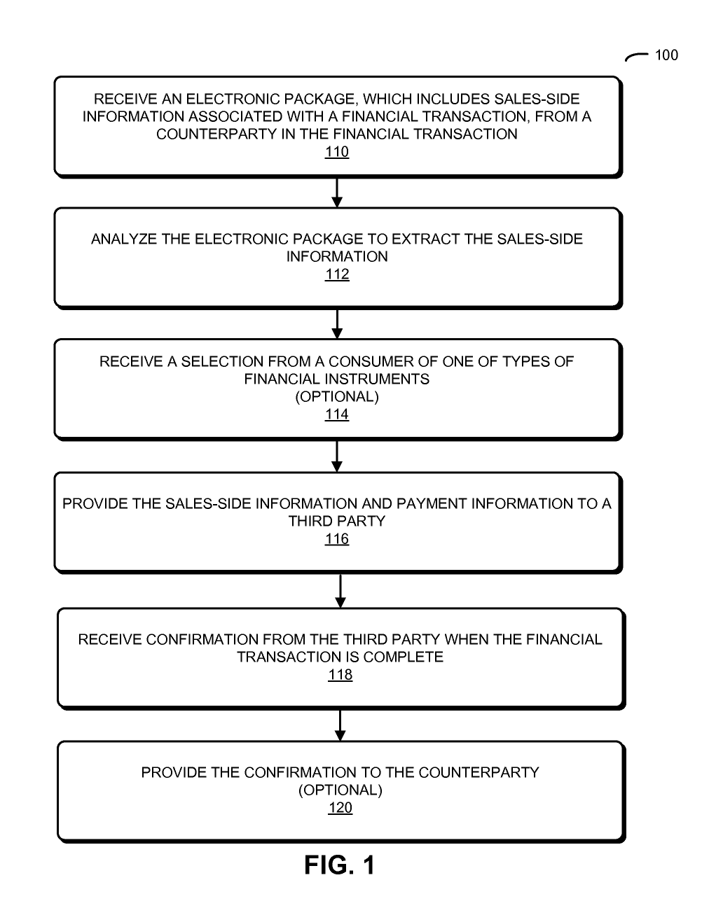

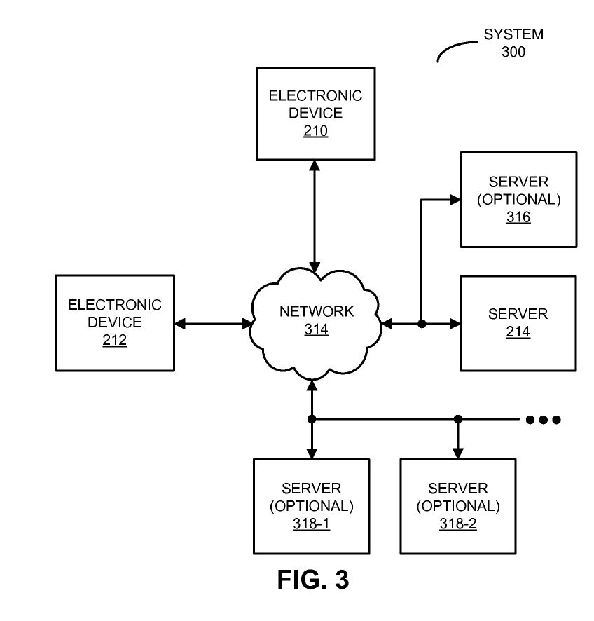

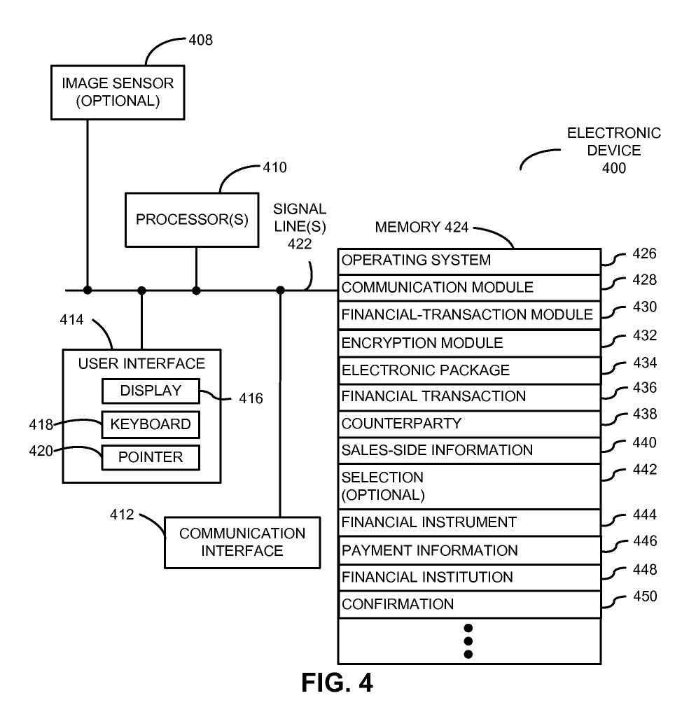

We now describe embodiments of the financial technique. FIG. 1 presents a flow chart illustrating a method 100 for conducting a financial transaction (such as purchasing a product and/or a service), which may be performed by a system (such as system 300 in FIG. 3) and/or an electronic device (such as electronic device 400 in FIG. 4) in this system. During operation, the electronic device (such as a cellular telephone) receives an electronic package, which includes sales-side information associated with the financial transaction, from a counterparty in the financial transaction (operation 110). For example, the electronic package may be received from another electronic device that is associated with the counterparty, such as: another cellular telephone, a cash register and/or, more generally, a point-of-sale terminal. Note that the other electronic device may be portable and/or stationary. Thus, method 100 may be used for financial transactions that are conducted online and/or using a portable electronic device, such as a cellular telephone.

The electronic package may be received (operation 110) in a variety of ways. For example, the electronic package may be conveyed via a network using a communication technique such as near-field communication or text messaging. Alternatively or additionally, the electronic package may include an image that may be: received in an electronic format, scanned from a physical copy, or captured, for example, using an image sensor. Thus, the other electronic device may display the electronic package on a display and the electronic device may capture the image using an image sensor (such as a built-in camera). Alternatively, the other electronic device may print out a physical copy of the electronic package, which is subsequently scanned in by the electronic device. In an exemplary embodiment, the image includes a one- or a two-dimensional spatial pattern, such as a barcode and/or a Quick Response code. More generally, the image may be an arbitrary technique for presenting information in a visual format.

Then, the electronic device analyzes the electronic package to extract the sales-side information (operation 112). This analysis may involve image processing of the image.

Moreover, the electronic device provides the sales-side information and payment information to a third party (operation 116), where the process of providing is initiated by a consumer in the financial transaction (as opposed to the counterparty), and the third party completes the financial transaction. This third party may include a financial institution that provides a financial instrument (such as a credit card or a debit card) to the consumer or that provides an online payment service.

Next, the electronic device receives confirmation (such as another one- or two-dimensional barcode) from the third party when the financial transaction has been completed (operation 118). After receiving the confirmation (operation 118), the electronic device may optionally provide the confirmation to the counterparty (operation 120). (Alternatively, the third party may optionally provide the confirmation directly to the counterparty.) For example, the confirmation may be communicated via a network to the other electronic device or the other electronic device may scan or capture another image of the confirmation. Furthermore, in response to receiving the confirmation, the counterparty may optionally provide a receipt to the consumer.

The sales-side information may include a variety of information associated with the financial transaction, such as: a timestamp (which may be used to limit an amount of time between operation 110 and the completion of the financial transaction), the transaction identifier, counterparty information (e.g., a name, an address, a telephone number, etc.), a transaction amount (which may include sales tax and/or a tip amount) and/or a product or service being purchased. Thus, the sales-side information may include information associated with a bill or an invoice (and, more generally, terms for payment of a bill or an invoice).

In some embodiments, the sales-side information includes types of financial instruments accepted by the counterparty. Thus, after extracting the sales-side information (operation 112), the electronic device may optionally receive a selection from the consumer of one of the types of financial instruments (operation 114), and the payment information may include the selected type of financial instrument. In this way, the counterparty may restrict or limit the types of financial instruments that can be used in the financial transaction (i.e., the types of financial instruments accepted by the counterparty) and the consumer can select the type of financial instrument that works best for them.

Moreover, in some embodiments the electronic package includes information specifying one or more locations (such as a link to a web page or website) where the financial transaction can be completed. If the consumer activates such a link, a web page or a web site where the consumer can complete the financial transaction (such as one associated with the third party) may be displayed. Thus, the sales-side information may include multiple locations that, respectively, correspond to different financial instruments the counterparty accepts.

Furthermore, in some embodiments the sales-side information may not include all the information for the financial transaction. For example, there may be information that is contextually relevant, but which is accessed by the electronic device using an external source, such as the details of a financial institution that processes payments to the counterparty.

In method 100, note that the financial transaction may be completed without providing the counterparty financial information about a financial instrument used by the consumer to conduct the financial transaction. In this way, security of the financial information may be increased.

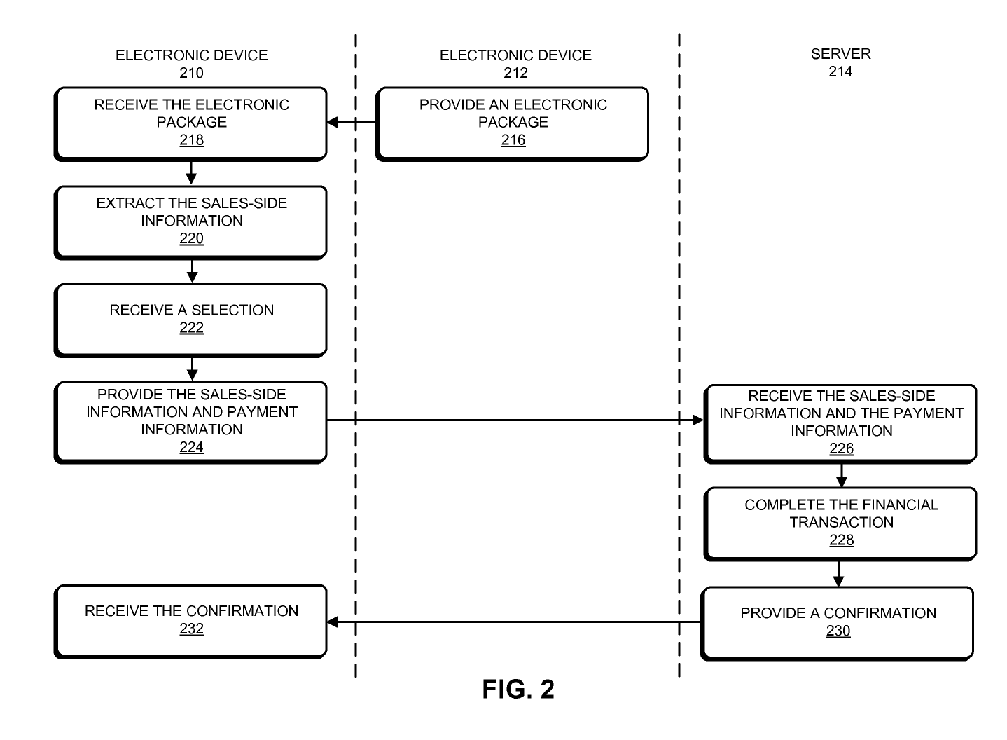

As noted previously, the financial technique may be implemented using electronic devices, computers and/or servers, which may communicate through a network, such as a cellular-telephone network and/or the Internet (e.g., using a client-server architecture). This is illustrated in FIG. 2, which presents a flow chart illustrating method 100. During this method, electronic device 212 (which is associated with the counterparty in the financial transaction) may provide an electronic package (operation 216). This electronic package may include the sales-side information associated with the financial transaction. For example, the sales-side information may be included in an image, such as a two-dimensional barcode. Then, electronic device 210 (which is associated with the consumer) may receive the electronic package (operation 218). Note that providing the electronic package (operation 216) may involve: transmitting the electronic package via a network, printing a physical copy of the electronic package, and/or displaying the electronic package on a display. Similarly, receiving the electronic package (operation 218) may involve: receiving the electronic package via a network, scanning the physical copy; and/or capturing an image using an image sensor.

In response to receiving the electronic package (operation 218), electronic device 210 extracts the sales-side information (operation 220) by analyzing the electronic package. If the sales-side information includes types of financial instruments accepted by the counterparty associated with electronic device 212, electronic device 210 may optionally receive a selection (operation 222) from the consumer of a type of financial instrument.

Then, electronic device 210 provides the sales-side information and the payment information (operation 224), which may include the selected type of financial instrument, to server 214. This server may be associated with a third party, such as a provider of the financial instrument.

After receiving the sales-side information and the payment information (operation 226), server 214 completes the financial transaction (operation 228). Then, server 214 provides (operation 230) and electronic device 210 receives (operation 232) a confirmation that the financial transaction is complete. In some embodiments, electronic device 210 optionally provides the confirmation (not shown), which is then optionally received (not shown) by electronic device 212.

In some embodiments of method 100 (FIGS. 1 and 2), there may be additional or fewer operations. Moreover, the order of the operations may be changed, and/or two or more operations may be combined into a single operation.

In an exemplary embodiment, when a customer (i.e., the consumer) wants to pay a bill at a restaurant or store (and, more generally, a business), an employee (such as a waiter) uses an electronic device to provide the electronic package. As noted previously, the sales-side information in the electronic package may, at least in part, be included in an image, such as a barcode. In some embodiments, the barcode is pre-determined or pre-existing. However, in other embodiments, the barcode is generated dynamically for each financial transaction. For example, the employee could use a point-of-sale terminal to generate a Quick Response code that uniquely encodes the sales-side information associated with the financial transaction (in this example, the bill) that is being requested by the employee.

The Quick Response code may be displayed on a display, and the consumer may capture this barcode, for example, by scanning it using a camera in their cellular telephone. After a software application executing on the consumer's cellular telephone extracts the sales-side information associated with the financial transaction, the consumer can use the software application to provide this information to a financial institution (such as the consumer's bank), either directly or via a provider of a system that implements the financial technique, so that the restaurant or store can be credited or paid without requiring the consumer to provide their sensitive financial information to the employee.

We now describe embodiments of the system and the electronic device, and their use. FIG. 3 presents a block diagram illustrating a system 300 that performs methods 100 (FIGS. 1 and 2). In this system, a business (the counterparty) may conduct a financial transaction with a consumer. In particular, an employee of the business may use electronic device 212 to conduct the financial transaction. This employee may use a software product, such as a software application that is resident on and that executes on electronic device 212. (Alternatively, the employee may interact with a web page that is provided by optional server 316 via network 314, and which is rendered by a web browser on electronic device 212. For example, at least a portion of the software application may be an application tool that is embedded in the web page, and which executes in a virtual environment of the web browser. Thus, the application tool may be provided to the employee or the counterparty via a client-server architecture.) This software application may be a standalone application or a portion of another application that is resident on and which executes on electronic device 212 (such as a software application that is provided by optional server 316 or that is installed and which executes on electronic device 212).

Using the software application, the employee may provide, via network 314, the electronic package with the sales-side information associated with the financial transaction to electronic device 210. Alternatively or additionally, the employee may use the software application to print a physical copy of the electronic package or to display the electronic package on a display.

When receiving the electronic package, the consumer may use the same or another software product, such as a software application that is resident on and that executes on electronic device 210. (Alternatively, the consumer may interact with a web page that is provided by optional server 316 via network 314, and which is rendered by a web browser on electronic device 210. For example, at least a portion of the software application may be an application tool that is embedded in the web page, and which executes in a virtual environment of the web browser. Thus, the application tool may be provided to the consumer via a client-server architecture.) This software application may be a standalone application or a portion of another application that is resident on and which executes on electronic device 210 (such as a software application that is provided by optional server 316 or that is installed and which executes on electronic device 210).

As discussed previously, electronic device 210 may receive the electronic package, for example, via network 314, by scanning it in or by capturing an image (such as a digital photograph) of the electronic package. Subsequently, the software application executing on electronic device 210 may extract the sales-side information associated with the financial transaction.

In some embodiments, the sales-side information includes types of financial instruments accepted by the business. In these embodiments, the consumer may specify to electronic device 210 which of these types of financial instruments the consumer will use to complete the financial transaction.

Then, the software application executing on electronic device 210 may provide, via network 314, the sales-side information and the payment information (which may include the selected type of financial instrument) to server 214, which is associated with the third party (such as the financial institution that provides a credit card or a debit card to the consumer).

Moreover, server 214 may complete the financial transaction using the sales-side information and the payment information. For example, server 214 may: validate the financial transaction, debit an account associated with the consumer, and credit an account associated with the business. This last operation may involve communicating information, via network 314, to one of optional servers 318, which is associated with another financial institution that provides banking services to the business.

Next, server 214 may provide, via network 314, confirmation that the financial transaction has been completed to electronic device 210. In some embodiments, electronic device 210 provides the confirmation to electronic device 212 via network 314.

In some embodiments, the sales-side information and the payment information are routed to server 214 by optional server 316, which functions as an intermediary. Similarly, the confirmation may be routed to electronic device 210 by optional server 316. Note that this server may be associated with a service provider that offers the financial technique as a service. Furthermore, in embodiments where the sales-side information includes a dynamically generated barcode, this barcode may be generated locally (for example, in electronic device 212) or remotely (for example, by optional server 316).

Note that information in system 300 may be stored at one or more locations in system 300 (i.e., locally or remotely). Moreover, because this data may be sensitive in nature, it may be encrypted. For example, stored data and/or data communicated via network 314 may be encrypted.

In the preceding example of the operations performed by electronic devices, computers and/or servers in system 300, note that at least some of these operations may be based on an explicit instruction or command that is received from the consumer or the counterparty, or without the explicit instruction or command.

FIG. 4 presents a block diagram illustrating an electronic device 400 that performs method 100 (FIGS. 1 and 2), such as electronic device 210 (FIGS. 2 and 3). Electronic device 400 includes one or more processing units or processors 410, a communication interface 412, a user interface 414, and one or more signal lines 422 coupling these components together. Note that the one or more processors 410 may support parallel processing and/or multi-threaded operation, the communication interface 412 may have a persistent communication connection, and the one or more signal lines 422 may constitute a communication bus. Moreover, the user interface 414 may include: a display 416, a keyboard 418, and/or a pointer 420, such as a mouse.

Memory 424 in electronic device 400 may include volatile memory and/or non-volatile memory. More specifically, memory 424 may include: ROM, RAM, EPROM, EEPROM, flash memory, one or more smart cards, one or more magnetic disc storage devices, and/or one or more optical storage devices. Memory 424 may store an operating system 426 that includes procedures (or a set of instructions) for handling various basic system services for performing hardware-dependent tasks. Memory 424 may also store procedures (or a set of instructions) in a communication module 428. These communication procedures may be used for communicating with one or more computers and/or servers, including computers and/or servers that are remotely located with respect to electronic device 400.

Memory 424 may also include multiple program modules (or sets of instructions), including: financial-transaction module 430 (or a set of instructions) and/or encryption module 432 (or a set of instructions). Note that one or more of these program modules (or sets of instructions) may constitute a computer-program mechanism.

During the financial technique, electronic device 400 may receive electronic package 434 associated with a financial transaction 436 from a counterparty 438 in financial transaction 436. For example, electronic package 434 may be: received using communication interface 412 and communication module 428; or scanned or captured using optional image sensor 408. In response to receiving electronic package 434, financial-transaction module 430 may extract sales-side information 440 that was included in electronic package 434.

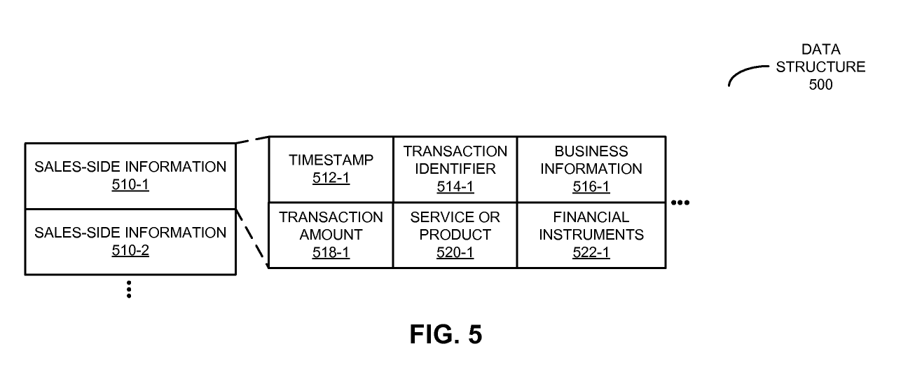

As shown in FIG. 5, which illustrates a data structure 500, this sales-side information may be included in a data structure. In particular, data structure 500 may include sales-side information 510 associated with different financial transactions. For example, sales-side information 510-1 may include: a timestamp 512-1, a transaction identifier 514-1, business information 516-1 (e.g., a name, an address, a telephone number, etc.), a transaction amount 518-1, a service or a product 520-1 being purchased, and/or types of financial instruments 522-1 accepted by counterparty 438 (FIG. 4).

Referring back to FIG. 4, if sales-side information 440 includes types of financial instruments 522-1 (FIG. 5), financial-transaction module 430 may receive an optional selection 442 from the consumer of a type of financial instrument (such as financial instrument 444) to use when completing financial transaction 436.

Then, financial-transaction module 430 may provide sales-side information 440 and payment information 446 (which may include optional selection 442) to a third party, such as a financial institution 448 that is associated with financial instrument 444. For example, financial institution 448 may have issued financial instrument 444 to the consumer.

After financial institution 448 completes financial transaction 436, financial-transaction module 430 may receive confirmation 450 that financial transaction 436 has been completed. In some embodiments, financial-transaction module 430 optionally provides confirmation 450 to counterparty 438.

Because information in electronic device 400 may be sensitive in nature, in some embodiments at least some of the data stored in memory 424 and/or at least some of the data communicated using communication module 428 is encrypted using encryption module 432.

Instructions in the various modules in memory 424 may be implemented in: a high-level procedural language, an object-oriented programming language, and/or in an assembly or machine language. Note that the programming language may be compiled or interpreted, e.g., configurable or configured, to be executed by the one or more processors 410.

Although electronic device 400 is illustrated as having a number of discrete items, FIG. 4 is intended to be a functional description of the various features that may be present in electronic device 400 rather than a structural schematic of the embodiments described herein. In practice, and as recognized by those of ordinary skill in the art, the functions of electronic device 400 may be distributed over a large number of servers or computers, with various groups of the servers or computers performing particular subsets of the functions. In some embodiments, some or all of the functionality of electronic device 400 may be implemented in one or more application-specific integrated circuits (ASICs) and/or one or more digital signal processors (DSPs).

Electronic devices (such as electronic devices 210 and 212 in FIGS. 2 and 3), as well as computers and servers in system 300 (FIG. 3) may include one of a variety of devices capable of manipulating computer-readable data or communicating such data between two or more computing systems over a network, including: a personal computer, a laptop computer, a tablet computer, a mainframe computer, a portable electronic device (such as a cellular phone or PDA), a server, a point-of-sale terminal and/or a client computer (in a client-server architecture). Moreover, network 314 (FIG. 3) may include: the Internet, World Wide Web (WWW), an intranet, a cellular-telephone network, LAN, WAN, MAN, or a combination of networks, or other technology enabling communication between computing systems.

Electronic device 210 (FIGS. 2 and 3), electronic device 212 (FIGS. 2 and 3), system 300 (FIG. 3), electronic device 400 (FIG. 4) and/or data structure 500 may include fewer components or additional components. Moreover, two or more components may be combined into a single component, and/or a position of one or more components may be changed. In some embodiments, the functionality of electronic device 210 (FIGS. 2 and 3), electronic device 212 (FIGS. 2 and 3), system 300 (FIG. 3) and/or electronic device 400 may be implemented more in hardware and less in software, or less in hardware and more in software, as is known in the art.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. An electronic-device-implemented method for conducting a financial transaction, the method comprising:
receiving, from a counterparty in the financial transaction, an electronic package which includes sales-side information associated with the financial transaction;
using the electronic device, analyzing the electronic package to extract the sales-side information;
providing the sales-side information and payment information to a third party, wherein the process of providing is initiated by a consumer in the financial transaction, and wherein the third party completes the financial transaction; and
receiving, from the third party, confirmation when the financial transaction has been completed.

2. The method of claim 1, wherein the electronic package includes an image; and
wherein analyzing the electronic package involves image processing of the image.

3. The method of claim 2, wherein the image includes a two-dimensional spatial pattern.

4. The method of claim 2, wherein the image includes a barcode.

5. The method of claim 2, wherein the image includes a Quick Response code.

6. The method of claim 2, wherein receiving the electronic package involves capturing the image.

7. The method of claim 1, wherein the sales-side information includes types of financial instruments accepted by the counterparty;
wherein, after extracting the sales-side information, the method further includes receiving a selection of one of the types of financial instruments from the consumer; and
wherein the payment information includes the selected type of financial instrument.

8. The method of claim 1, wherein, after receiving the confirmation, the method further includes providing the confirmation to the counterparty.

9. The method of claim 1, wherein the third party includes a financial institution that provides the selected type of financial instrument to the consumer.

10. The method of claim 1, wherein the electronic package includes information specifying a location where the financial transaction can be completed.

11. The method of claim 1, wherein the financial transaction is completed without providing the counterparty financial information about a financial instrument used by the consumer to conduct the financial transaction.

12. A computer-program product for use in conjunction with an electronic device, the computer-program product comprising a non-transitory computer-readable storage medium and a computer-program mechanism embedded therein, to conduct a financial transaction, the computer-program mechanism including:
instructions for receiving, from a counterparty in the financial transaction, an electronic package which includes sales-side information associated with the financial transaction;
instructions for analyzing the electronic package to extract the sales-side information;
instructions for providing the sales-side information and payment information to a third party, wherein the process of providing is initiated by a consumer in the financial transaction, and wherein the third party completes the financial transaction; and
instructions for receiving, from the third party, confirmation when the financial transaction has been completed.

13. The computer-program product of claim 12, wherein the electronic package includes an image; and
wherein analyzing the electronic package involves image processing of the image.

14. The computer-program product of claim 13, wherein receiving the electronic package involves capturing the image.

15. The computer-program product of claim 12, wherein the sales-side information includes types of financial instruments accepted by the counterparty;
wherein, after extracting the sales-side information, the computer-program mechanism further includes instructions for receiving a selection of one of the types of financial instruments from the consumer; and
wherein the payment information includes the selected type of financial instrument.

16. The computer-program product of claim 12, wherein, after receiving the confirmation, the computer-program mechanism further includes instructions for providing the confirmation to the counterparty.

17. The computer-program product of claim 12, wherein the third party includes a financial institution that provides the selected type of financial instrument to the consumer.

18. The computer-program product of claim 12, wherein the electronic package includes information specifying a location where the financial transaction can be completed.

19. The computer-program product of claim 12, wherein the financial transaction is completed without providing the counterparty financial information about a financial instrument used by the consumer to conduct the financial transaction.

20. A computer system, comprising:
a processor;
memory; and
a program module, wherein the program module is stored in the memory and configurable to be executed by the processor to conduct a financial transaction, the program module including:
instructions for receiving, from a counterparty in the financial transaction, an electronic package which includes sales-side information associated with the financial transaction;
instructions for analyzing the electronic package to extract the sales-side information;
instructions for providing the sales-side information and payment information to a third party, wherein the process of providing is initiated by a consumer in the financial transaction, and wherein the third party completes the financial transaction; and
instructions for receiving, from the third party, confirmation when the financial transaction has been completed.
